(19) United States
(12) Patent Application Publication
(10) Pub. No.: US 2025/0046297 A1
(43) Pub. Date: Feb. 6, 2025

(54) MEDIA SYSTEM VALIDATION

(71) Applicant: LEXMARK INTERNATIONAL, INC., LEXINGTON, KY (US)

(72) Inventors: PETER STEWART DAVIDSON, JR., LEXINGTON, KY (US); KEITH BRYAN HARDIN, LEXINGTON, KY (US); MICHAEL JAMES HAROLD HOLMES, GEORGETOWN, KY (US); ROBERT HENRY MUYSKENS, LEXINGTON, KY (US)

(21) Appl. No.: 18/793,375

(22) Filed: Aug. 2, 2024

Related U.S. Application Data
(60) Provisional application No. 63/530,577, filed on Aug. 3, 2023.

(51) Int. Cl. G10L 15/06

(52) U.S. Cl. CPC G10L 15/06

(57) ABSTRACT

Sound or video systems are used to deliver predetermined content to a customer audience. It is important to validate that the intended material is being received and understood by the targeted audience. Sound or video system service providers prove their value by providing feedback metrics that the system is working as expected. The present invention automates and enhances this process and makes the validation continuous for constant validation at a much lower cost. Enhancements creates metrics beyond a human's ability to discern the quality of the service. The also includes features that can automatically determine the cause and recommended solution if the system's performance is not as expected. The metrics are then aggregated for full system wide operation in a graphical and tabular analytic interface.

### CROSS REFERENCES TO RELATED APPLICATIONS

Pursuant to 35 U.S.C. § 119, this application is related to and claims the benefit of the provisional application Ser. No. 63/530,577, filed Aug. 2, 2023, titled “Media System Validation.”

### BACKGROUND

### 1. Field of the Invention

This invention relates generally to validation of video or sound systems.

### 2. Description of the Related Art

There is a known embodiment that has been improved to practice audio validation using an industrial strength audio search algorithm referred to here as the first algorithm. This algorithm takes a sample audio clip, such as that from a microphone, and compares it to the source audio and returns a score indicating the likelihood that the sampled clip is contained in the source audio.

For the source and sample clips, hashes are created of pairs of peaks in the audio's frequency spectrum. These hashes are the fingerprint of the clip and can be compared. This is completed in the following steps: (1) the audio clip is divided into equal length windows; and (2) each window is analyzed to determine some frequencies with the highest spectral energy—these are the frequency peaks; (3) each of these peaks, here referred to as anchor peaks, are matched with other peaks (later in time) inside of a target zone, which is bound by an upper and lower frequency equidistant from the anchor peak and by a start and end time delta from the anchor peak; (4) the hash for this anchor peak is created from the frequency of the anchor peak, the frequency of the peak in the target zone, and the time delta between the two peaks. This is joined to the time of the anchor peak relative to the audio clip. Data binning is used to store the frequencies in 10 bits (1024 bins). For an anchor peak and time of f1:t1 and a target zone peak and time f2:t2 then: Hash:time=[f1:f2:Dt]:t1, where f1 and f2 are 10 bits each, Dt is 12 bits, and t1 is 32 bits. This allows for the Hash to be stored in 32 bits, and then along with the time t1, stored in 64 bits; (5) These Hash:time pairs are created for each peak in the audio clip and are called the fingerprint.

To compare two clips, the two fingerprints are analyzed to determine the number of matching and time-aligned hashes. This number is returned as a score, the higher the number, the more likely the sample clip is contained in the source clip.

### SUMMARY OF THE INVENTION

Sound or video systems are used to deliver predetermined content to a customer audience. It is important to validate that the intended material is being received and understood by the targeted audience. Sound or video system service providers prove their value by providing feedback metrics that the system is working as expected. The current method to get this feedback is to send personnel to a location to inspect the system and report on the system's operation. This can be done with a simple checklist or augmented with a short recording of the system to provide objective proof of operation. This provides a limited sampling of the operation, and the cost of this validation is proportional to the number of visits and time spent at each location. The current invention automates and enhances this process and makes the validation continuous for constant validation at a much lower cost. Enhancements create metrics beyond a human's ability to discern the quality of the service. The also includes features that can automatically determine the cause and recommended solution if the system's performance is not as expected. The metrics are then aggregated for full system wide operation in a graphical and tabular analytic interface.

### BRIEF DESCRIPTION OF THE DRAWINGS

Having thus described the invention in general terms, reference will now be made to the accompanying drawings, which are not necessarily drawn to scale, and wherein:

FIG. 1 shows the enrollment of a reference signal.

FIG. 2 shows a block diagram of the edge-based hardware operation for the video and sound check system.

FIG. 3 shows a source audio stream speaker of a sound check system where a microphone listening device is present.

FIG. 4 shows a block diagram for a cloud based sound check.

FIG. 5 depicts a scene at a train station with display zones identified.

FIG. 6 shows a method for adding constellations in a first out buffer.

FIG. 7 shows a method for sending a constellation to a server without creating alternate chunks of data.

FIG. 8 shows a detailed server flow chart.

FIG. 9 shows a scoring server and sample flow chart detailed.

FIG. 10 shows start video signage identification process.

FIG. 11 shows the edge computer ecosystem.

FIG. 12 shows no gaps between a sequential source sound clips.

FIG. 13 shows the scoring process.

FIG. 14 shows the plot of frequency peaks and the pair box.

FIG. 15 shows a configuration using a USB microphone.

FIG. 16 shows a configuration using a USB microphone with an USB extender.

FIG. 17 shows a configuration with a second edge device running Audio Sampler.

FIG. 18 shows a configuration with multiple edge devices in different zones.

FIG. 19 shows a configuration using low-cost devices and a BLE mesh network.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having” and variations thereof herein is meant to encompass the items listed thereafter and equivalents thereof as well as additional items. Terms such as “about” and the like are used to describe various characteristics of an object, and such terms have their ordinary and customary meaning to persons of ordinary skill in the pertinent art.

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

Validation of video or sound systems be a distributed set of microphones or cameras within a targeted space. The system uses complex digital algorithms to validate against reference signals of the intended content. Validation metrics give the performance level of the system in reference to the environmental conditions that may reduce the ability of the targeted audience to perceive the content. The metrics assures the fee providers that the system is working within the specified parameters. Validation metrics also can give insights to problem determination when something is defective in the system. The metrics will also include identifying environmental factors that may impede the target audience from receiving content favorably. Counter measures can be automatically deployed or suggestions for remedy may be provided. The metrics may be aggregated into a graphical user interface that give a fast and easy method to see the health of a large fleet of systems operation with the ability to analyze to a single instance of one operation to one streaming output and one observation location.

An edge computer streaming service can provide audio and video streaming to, e.g., retail, amusement, exchange, training, office, or control spaces that contain both customer interest content interspersed with advertising content. This content may be sent to a public address (PA) system or distributed to video screens with speakers.

Streaming services and operations may validate that the intended audio or video is being heard or seen in the space respectively. The audio is a mixture of voice advertisement and music that could be interrupted by a defect in the PA system, a speaker defect, or simply a cable becoming unplugged. Hence, verification that the content is being delivered to the correct location is needed. In the same way, video streaming may be obstructed or inoperative at the point of distribution.

The disclosed invention uses sensor modules with a microphone for sound or camera for video. The devices are placed where targeted customers will be located within range of the streaming services. One key aspect of this invention is to minimize the amount of data sent from the sensor modules to the device serving the streaming information. Data compression is needed to reduce the bandwidth of the communications and the processing time needed at the serving device. The compression reduces the energy required by the sensing modules, which allows for longer battery operation when desired. The communications method can be at least WiFi, ethernet, LoRaWAN, Bluetooth, or Ultra-Wide Bandwidth (UWB).

For audio systems, the sound heard by the sensor will have a mixture of the PA system plus echoes, such as background noises (talking and other ambient noises). The content is not known in advance by the audio sensor module. However, the server has access to the content as it is being sent to the audio input that is presented to the PA system.

Algorithms in software operating in real time to continuously detect characteristics of the input presented to the PA system. A first algorithm uses a technique found with mobile phones that determines what music is being “played.” The existence of the first algorithm is prior art that measures isolated spectral frequencies at a given time and again at ranges of later time. Combinations of these pairs of frequencies are combined to create a hash number creating a unique fingerprint. Contiguous samples are taken for a song to create a library of hash values. When a song is requested for identification later, a short snippet is used to create similar hashes. These hashes are sent to where the library of hashes is stored to find the highest set of matches. This match then indicates the song that needed to be identified.

In contrast, the first embodiment of the present invention uses a process where continuous streams are to be validated against a snippet that is heard by a microphone or camera in a customer space. This is achieved by creating two-time overlapping sequences of reference streams from the server device. Many features are added for using and interpreting the metrics that are returned. The audio reference comparison is then extended into video streaming.

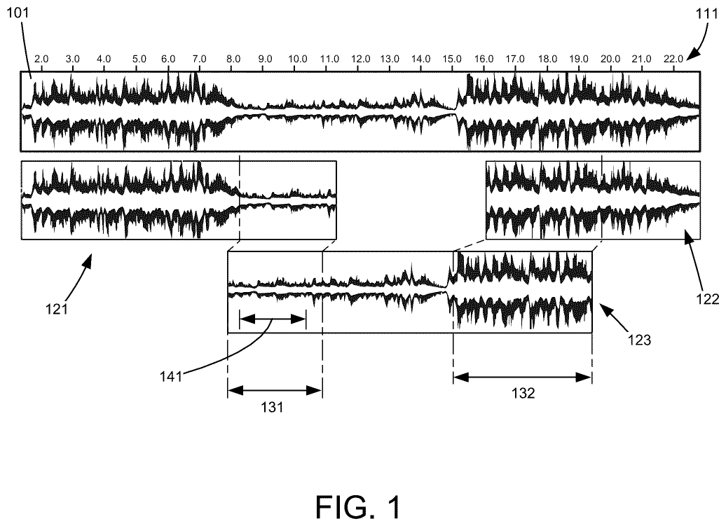

FIG. 1 shows the enrollment of a reference signal, where an audio signal 101 that lasts 23 seconds in time as shown on the scale 111. The audio signal 101 is divided into separate audio stream portions 121, 122, 123 for processing. The three audio stream portions 121, 122, 123 are approximately 11 seconds long with approximately 4 seconds of overlap 131, 132 to the alternating portions. That is, overlap 131 is that between audio stream portions 121 and 123, while overlap 132 is between audio stream portions 122 and 123. Note that a snippet 141 time length is chosen to be less than the overlapping time. This allows a full fingerprint snippet time to always be located within a particular portion of data. This guarantees that the matching score will always be high if the reference audio stream is present within the snippet taken from the remote microphone. The timing relationship are for example purposes but may be different depending on the application. The preferred implementation is for the overlap to be half the time of the audio stream portions. This increases the allowed size of the sample snippet.

The portions are organized in a database or logical sequence to keep a sliding window of reference signals from the present time to the end of a validation window. For example, a large mall or retail area may have hundreds of speakers or displays. Each sensing device must process the current time snippet and send the results to a central reference location to compare the snippets for a match, to the stored portions. The portion retention must be long enough in time so that all matching processing is done within the stored window. The remote snippets can be orchestrated dynamically to modify the time between when the snippets are returned. If faster response times are required, then additional processing can be added, or critical locations will get faster snippet frequencies with lower priority can be slowed down.

A second embodiment uses machine learning (ML) to create classifications of sound types to be matched in time is a second algorithm. This detection method second algorithm would be a correlation of several predetermined sound or video snippets from the audio or video streams. For example, the most basic could be just a few cycles of a pure sinusoidal snippets (similar to a graphics equalizer (GEQ)) at different frequencies. For each of the snippets, a separate state machine would send a flag if the correlation were above a threshold. Thresholds and duration requirements would be dynamic so that the desired hit rate would be acquired. The classifier ML may be trained to identify a range of instruments, voices and expected sounds that would be expected to be present in the reference signal. These sounds would be identified with time stamps (relative or absolute) for the start or end of the classification. The reference classification would create a window of metrics like the length of classification with time. The reference classification would be stored for a sufficient time so that the slowest remote device could transmit its comparison data and be processed. The remote sensors will have similar classification software that detect the same sound sets as the reference signal uses. Each time a positive classification is made at the remote sensor, the classification type and times are sent for a match. Signals received at the same time intervals within an allowable tolerance will be considered a match.

If validation is required for every 30 seconds, then the duration and threshold would self-adjust until that rate is created. The number of matches can be controlled by choosing the signal reference types. The algorithm would be a sliding convolution or correlation of test signal snippets. The best mode would be to have 5 to 7 state machines running in parallel to cover different parts of the spectrum. A Digital Fourier Transform (DFT) or a sliding convolution would be more applicable to a lightweight processor that may be battery operated.

The same algorithms would be on the sensor device in the remote location. The dynamic thresholds would be communicated to the sensor that would adjust and listen. If a threshold is found, then a packet is sent with the state machine type and time stamp. The algorithm then performs matches of the time and quantity of the sounds for a report.

A known prior art loopback technique setup on a Linux system can be used to capture streamed audio or video. “ALSA audio” is an application that allows the audio output of the computer to be looped back into the system as a stream. This can be used to get access to the audio information on the computer. Similar techniques are available to loopback video for display matching via software or through hardware devices like video capture with loop-out features. The reference video may be sampled at the central distribution computer video output or at each media device that drives a particular display.

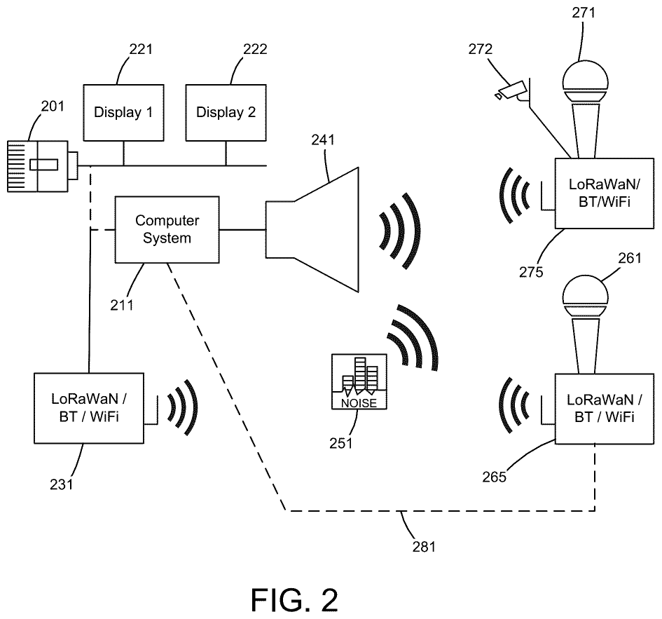

FIG. 2 shows a block diagram of the hardware operation for the video and sound check system. The Ethernet connection 201 provides the computer system 211 with the information needed to out an audio stream to a public address system 241. The content is music, voice, and advertising in any combination in time. This audio is picked up by a remote microphone 261, 271 with the addition of noise 251 and other background sounds such as: people talking, clanging of products being moved, HVAC system hum and outdoor sounds made by cars or other equipment. The microphone can be a low-cost sensor and microprocessor system that can be distributed (or single) around the environment. The communication method can be LoRaWAN, Bluetooth, wireless 265, 275 or directly wired 281 to deliver a low data rate information to the computer system device 211. A gateway device 231 can be used to receive the signals to report the information back to the computer system device 211 for wireless communication methods.

The software operates to confirm that the audio stream created by the computer system to the PA system is being heard by people in the space. The characteristics being monitored are that (1) the system is loud enough, and (2) the correct audio stream is being heard over time. The verification rate should be less than every 20 seconds, but the report rate of the statistics can be greater than 1 minute. The verification and report rates may be defined by the user and dynamically adjusted from the computer system portal.

The microphone sensor may be battery operated if a low power sensing method is desired. The sensor may be powered if the monitor rate needs to be higher.

The real time continuous signal detection program will be sniffing (quick, short sensing) the audio or video output before going to PA system or displays. The detection would be a correlation of several predetermined sound snippets. The simplest could be just a few cycles of pure sinusoidal snippets (like a graphics equalizer (GEQ)) or a capture of a complex percussion instrument like a symbol of a drum set. For each of the snippets, a separate state machine would send a flag if the correlation were above a threshold. Thresholds and duration requirements would be dynamic so that the desired hit rate would be acquired. Assuming, for example, that the customer wants a verification every 20 seconds then the duration and threshold would self-adjust until that rate is created. The key is not to get too many or few. The algorithm would be a sliding convolution of test signal to snippet. A starting point would be to have three to five state machines running in parallel to cover different parts of the spectrum. An adaptive algorithm is used to balance the different sample sounds to limit or increase the match rate.

Music should be easily managed since the audio is spectrum rich but correct voice might be more difficult. Open-source programs can be used to select the snippet audio waveforms. Similar algorithms would be on a microphone sensor device in a remote location. The dynamic thresholds would be communicated to the sensor that would adjust and listen. If a threshold is found, then a packet is sent with the state machine type and time stamp. The system then does matches of the time and quantity of the sounds for a report.

In another embodiment, video systems can be validated in a similar way. Spectral contents of video frames may be analyzed by creating an aggregate representation of each frame. This is achieved by finding the sum of each color plane's intensity of the reference and remote measured zones that correspond to the same content. Additional details are provided below.

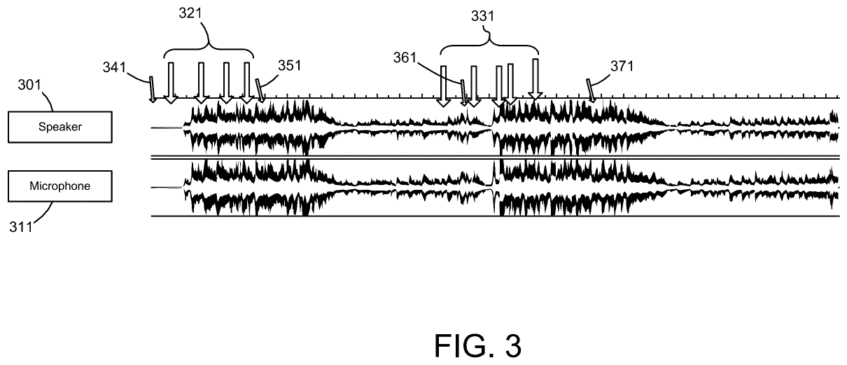

The steps are outlined below. First, a computer is used to stream sound from an internet radio station. The ALSA audio API is then used to capture a real-time streaming audio from both the speaker and microphone simultaneously. FIG. 3 shows a source audio stream speaker of a sound check system where a microphone listening device is present, where a speaker audio signal 301 and a microphone audio signal 311 with locations in time where sounds have similar snippet types. These time locations 321, 331, 341, 351, 361, 371 are found using a real-time algorithm for matching and outputs the time locations and/or number of events F (t) for both audio streams.

In a real system the microphone system transmits the algorithm output F (t) to the computer system that is streaming the audio. The speaker and microphone F (t) are compared to each other for agreement that the time alignment and number of F (t) are a significant statistical match. The edge system transmits the result of the statistical match to the platform. If the system does not have a match, then the microphone system can be instructed to record a short recording for later retrieval and analysis.

The second step is to determine the snippet types to search for in the streaming audio and microphone signals. The microphone audio will have additional noise that is not present in the streaming audio. It is desirable to also use very low power to enable the use of a battery that will last for years if possible. The battery constraint is removed if the remote device is powered but if a low power method is available then that would be a good feature. To minimize the power, the transmitted data from the microphone end node should be as little as possible and just often enough to do the detection. The sampling time of a microphone snippet and repetition rate should be adjustable depending on the application and accuracy needed. One assumption is that the end node microphone device has a real time clock that can be used for synchronization of the snippet times to the computer system stream.

A snippet library can be created to isolate recurring sounds that are expected in the audio stream to recur at a rate high enough to perform math with statistics that are advertised to the customer. A snippet can be as simple as a pulsed sine wave of a constant frequency or as complex as a cymbal hit within music with additional instruments and vocals of any language. An alternative would be to just highly compress a sound snippet from the microphone and return it to the computer system for alignment to the source stream but there may be a power cost to this approach due to the amount of data sent.

Another consideration is that there may be several microphone sensors scattered within a space to validate the sound is being heard for each speaker or area. For a quick implementation, assuming that there will be a power source would allow FFT methods to be used to create signature matching for a first pass. Power usage could be analyzed to determine if this method would be acceptable.

This invention could also be used to verify audio streams that are sourced in the cloud, to any device that can stream audio. The key is that the cloud performs the stream generation to have direct access to the audio and performs the sound snippet convolution to find the locations in time. The sensors in the field then send their versions of the sound characteristics through LoRaWAN or Bluetooth gateway directly to the cloud for comparison. The only differences are that the latency is much higher, and the bandwidth of data transmitted may be constrained. This can be compensated by the duration of the snippet, sample rate, and data length.

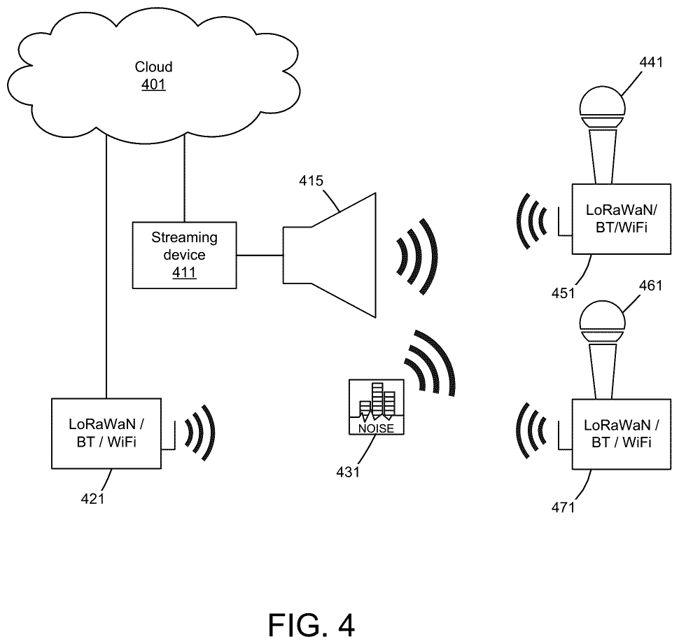

In FIG. 4, a cloud-based system is shown like the earlier edge-based version but the stream is sampled, and comparisons are made in the cloud 401. An edge streaming device 411 would be the primary system to validate the audio and video stream with the cloud system acting as a fail-over mode or vice versa. audio stream to a public address system 415. The content is music, voice, and advertising in any combination in time. This audio is picked up by a remote microphone 441, 461 with the addition of noise 431 and other background sounds such as: people talking, clanging of products being moved, HVAC system hum and outdoor sounds made by cars or other equipment. The microphone can be a low-cost sensor and microprocessor system that can be distributed (or single) around the environment. The communication method can be at least LoRaWAN, Bluetooth, wireless 451, 471. The wireless communication methods need a matching gateway device to receive the transmitted signal as represented by the LoRaWAN/BT/WiFi gateway 421. While at least one of the stated wires communications is need function some system may incorporate multiple communications protocols for redundancy.

For video system validation, FIG. 2 also depicts two video displays 221, 222 being driven from the computer system 211. These could be in any of the spaces previously mentioned. Video stream validations are important for the same reasons as audio stream validations. There are strong parallels between the two signal types. Both are easily monitored remotely giving valuable metrics about the health of the system. To observe displays 221, 222 a video camera 272 is placed to view of the displays content. If the video displays cannot be viewed by a single camera, then multiple cameras may be needed.

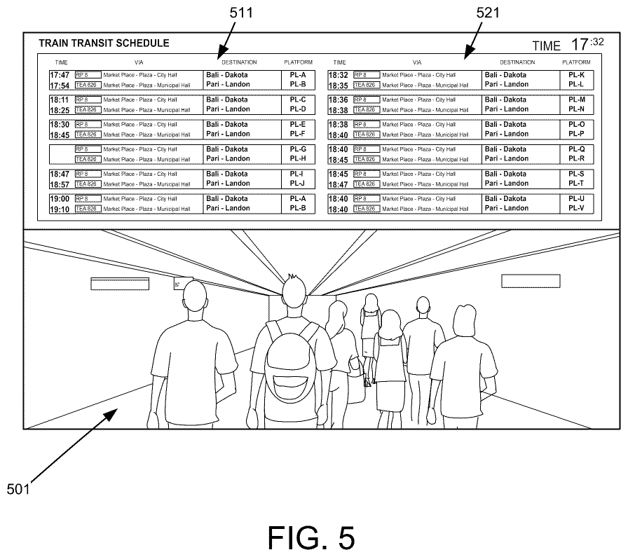

FIG. 5 depicts a scene at a train station 501. The schedule displays 511, 521 are critical for operation. A validation of content correctly making it to the correct locations would be important. The following describes the system operation and process steps for validation. Each of the screens 511, 521 will be served or streams from a media device. Typically, one set of graphics media device will be for each display. The validation system will need to have access to the reference video from processing. In this case, the reference is much more complex and informationally dense than an audio signal. The validation system in this case is not required to assess the full quality of the display. This was completed during the commissioning of the system when installed. The primary purpose of the validation is to make sure that the signal path from the reference source to the display has not been disrupted or accidentally switched to a different feed. These errors need to be quickly detected so that remediation can be initiated. There are various methods to perform the validation that each have different characteristics. The best mode for video is the one that requires the least setup changes and meets the conditions stated.

The steps to perform the validation of content on the train display screens 511, 521 include: (1) acquiring the reference video server signal as a digital signal for frame-by-frame processing; (2) converting the frame data into a signal that is easy to evaluate for a key fingerprint (hash); (3) using one or more remote cameras (not shown) to observe the displays 511, 521 of interest with sufficient line of sight; (4) isolating the displays of interest areas from each frame of the observing camera; (5) performing a similar key fingerprint analysis for each isolated display area from observing camera; (6) sending observed key fingerprint results to the evaluation server; (7) performing matches to see count of like hashes; and (8) setting a threshold to determine the acceptance or rejection criteria.

This flow follows the sound validation very closely. The video can be analyzed by a similar loopback method where the graphics are digitally captured with external hardware to be analyzed as the reference. To reduce the complexity of the video signal, each frame of the reference video is compressed by performing a summation of each color plane. For example, each red (R) pixel had an amplitude associated with its brightness. The total red for the frame is the sum of all the red brightness values. The same can be done for blue (B) and green (G) pixels as well. This represents 3-time varying signals much like the audio signal. For video sequences that vary in these signals may be represented as spectral content that have peaks that change sufficient to be used as the fingerprint hash. Scenes that do not have high variations will need a different metric. For this reason, each color is averaged over some snippet of time. This will give a fingerprint for the general background color to make sure that they match the observed zone in the camera watching the displays as a secondary check. For the scenes that do not change sufficiently over time, a test video sequence can be inserted into the reference video as a low frequency periodic check to give higher confidence that the system is working.

The time varying R, G, and B values are analyzed, and hashes are created in the method described for sound systems. These are stored in the chunk method with time stamps as described for the sound system.

The largest difference between video and sound verification is the sensing technique. This invention allows one camera to possibly have several displays of interest in a single view. For the sound example, a single reference signal is of interest. Other sounds are interpreted as noise. For camera scenes like in FIG. 5, there are two different reference video displays of interest at the same time. This is resolved by framing individual reference streams within a scene. For this application, all cameras and displays are in fixed locations. However, the techniques are extensible to moving displays and cameras.

The current invention takes advantage of machine learning (ML) algorithms to classify and identify displays with correlated references to be different zones withing the camera's view. The ML is trained to find rectangular regions where content is coordinated over time. The result is the two separate dashed areas around each display. These are designated as zones one and two from left to right respectively. Each zone then becomes a different observation for analysis. Each zone has the compressed sum of each frame for each color for hash creation just like the sound method. The average color over the snippet time is also recorded for analysis. This data is then sent to the server for matching analysis.

As with the sound validation the hashes are compared for a total match score. This is scaled and compared to thresholds for validation termination. If the validation is less than expected, then the average values are analyzed for a comparison. If this is not conclusive a snippet of reference video and observation is made available to an operator for manual inspection. Several snippets may be required for the manual determination. The key here is that a full analysis of a system can be mostly automated with limited manual intervention. This is better than sending a repair person after complaints have been made.

Another feature of system will record the reference signal and client signal for a short period of time when a system fault is detected. This will allow manual analysis of the defects later for system where immediate response is not required.

A system installed at a location will have at least one server device that coordinates the reference streams to different zones of PA areas or video systems. Many remote sensing devices will be installed within the same space and be present on the network in the same IP subnet. This will allow automatic discovery combined with the verification feature. The best mode will have the server and client units connect to a cloud-based platform that will have the means to download the application and all the configuration information directly into the units on location. This will include information that identifies the streams with their metadata, IP addresses with port designations for the client and server to communicate the verification data. This will work well when both devices have access to the internet and the cloud platform.

For cases that the internet is not available, the client device will broadcast UDP message for the server to respond with the server's IP address and identification with configuration data. The configuration data will tell the client's application what port to use and identify the stream that it is associated with. The stream identification will take some time for the process to reach the step of matching the client's data to the reference stream. Another method is for the client to send a multicast (MDNS) to the server and will operate as the broadcast message. The invention is that the identification of streams is used to associate the zones with the reference stream for automatic configuration. This must be combined with the network configuration process to operate withing a network.

Similar to human ears that may have more or less difficulty hearing in different environments, it is inevitable that the microphones placed in different locations, even within the same facility, will have different external influences that could affect the quality of the audio hashes that are generated, and thus affect the matching score that is ultimately computed. Examples of external influences could be things like a nearby air handler, a refrigerator compressor, or sound muffling due to a microphone sensing device being placed behind a television screen. In these cases, the overall system performance and accurate representation of audibility by a customer can benefit from a calibration routine that occurs when a new microphone/region or audio system is installed.

The calibration routine requires the installation technician be present on-site and capable of hearing. During a period of minimal non-standard ambient noise, the technician will initiate a calibration routine, which will begin a sequence of audio tones of various frequencies and amplitudes. The technician will stand within the appropriate region of the store for which a single sensor is intending to represent/detect. They will hold their finger on the screen of a mobile device during periods when the audio is clearly audible to their human ears and remove their finger from the mobile device during times when the audio is unclear, muffled, or inaudible. The timing of the human validation (finger press) is then cross-referenced against the matching score the system generates for the various frequencies, sound types (spoken voice vs music, etc.), and audio amplitudes. An acceptable matching score range for a single sensor is then calibrated across all sensors in a store to normalize the matching scores for each sensor and ultimately across multiple stores.

In the video space, the same structural calibration approach can be used, but with the sensor being a camera that is placed such that the video monitor being evaluated is within the field of view of the camera. During a calibration process, a known blinking pattern of color blocks is presented at various brightness levels (on screen) and at various pattern frequencies. An algorithm running on an edge computing device (specifically for initial calibration or routinely during off-hours) will pull in the camera feed data and known monitor video source imagery/video. The matching algorithm will generate a score for every calibration pattern shown on screen, and for various regions of the screen. The score at each region will inform the system of which portions of the screen are visible by a camera, and which portion of a camera's field of view covers a specific TV/monitor screen. Additionally, the impact of external lighting of affect the camera feed.

The system may also offer crowd source feedback. For example, a discount code announced on a video stream or audio that when used at the checkout gives user participation feedback from people that had the code. The code use can be valid for a limited time.

If customers are asked to clap or make a gesture when in response to a video or audio prompt, then this can be used to determine participation amounts within the space. A reward mechanism may be used to validate who is actively receiving the advertisement. A code can be announced or displayed then submitted at checkout. Similar codes could be used in conjunction with a phone application to validate the offering.

When the operator of such an audio and/or video validation system is required to deploy a solution across multiple locations per store, and then in hundreds or thousands of stores across the country or globe, it is critical that the validation results are visualized in an intuitive way. A primary use case for this audio validation solution is for media advertising, and the consumer-packaged-goods (or similar) product advertiser needs to know that their advertisement was visibly and audibly heard by potential end-customer/purchasers. When managing a system with that purpose an advertising network needs to be able to see aggregated views of the audience consume-ability of the media.

As the edge computing device in-store generates real-time matching results (multiple times/minute) it will determine if any sensor has experienced a change in matching performance sufficient to report a new running matching score up into the cloud for user visibility and subsequent remediation. The edge device can publish any combination of the individual sensor's matching scores, the average matching score for all sensor devices, or a regionalized group of sensors. The user is able to set matching score thresholds that they consider acceptable. Those thresholds can be expressed as multiple ranges, for example scores greater than X are “good,” scores between X and Y are “marginal,” and scores below Y are “bad.” The ranged score categories (good, bad, and marginal) can be visualized in a couple ways: (1) either as a sortable and searchable data table, (2) on a geographic map populated with colored dots—where the dot color is representative of the good/marginal/bad state of the audio matching performance for the media device and sensors at that location, or (3) in the form of a chart (such as a histogram of all sites average matching score).

These visualization methods make it easy for the manager of the media device fleet to seek and find locations where audio or video matching is struggling. The visualizations also assist in debugging the source of a matching issue. If all sensors within a facility are struggling to achieve good matching scores it would be indicative of the media volume across the site being turned off, or an audio amplifier possibly being disconnected. Alternatively, if a single sensor is generating poor matching scores while others within the facility are generating good matching scores, then it is possible that an individual speaker is failing, or that there is unacceptable ambient noise in the area (among other possible causes). The cloud application that is aggregating the fleets matching scores will present the user with an error notification and make an intelligent recommendation of potential issues that should be investigated. Microphones may be added to a location tag to click carts to validate audio and video from various locations and perspectives.

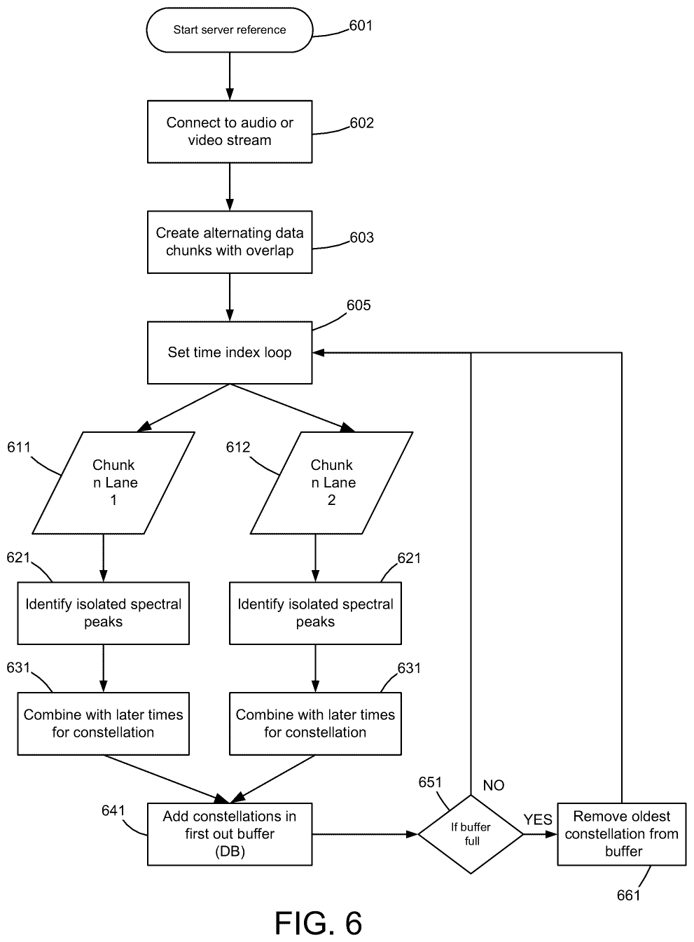

FIG. 6 shows a method for adding constellations in a first out buffer. The steps include: (1) starting the server reference 601; (2) connect to an audio or video stream 602; (3) create alternate data chunks with overlap 603; (4) set the time index loop 605; taking each chunk of data and divide it by lanes 611, 612; (5) identifying isolated spectral peaks in the chunks 621; (6) combining with later time for a constellation 631; (7) adding the constellations in a first out buffer 641; (8) if the buffer 651 is not full, returning to step (4); and if the buffer is full, removing the oldest constellation from the buffer 661.

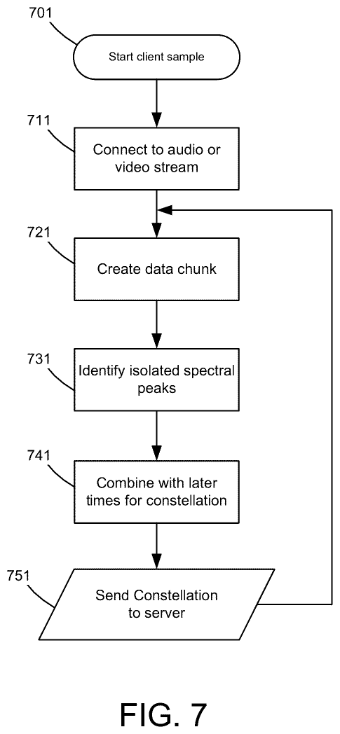

FIG. 7 shows a method for sending a constellation to a server without creating alternate chunks of data by (1) starting the client sample 701; (2) connect to an audio or video stream 711; (3) create a data chunks 721; (5) identifying isolated spectral peaks in the chunks 731; (6) combining with later time for a constellation 741; (7) send constellation to server for scoring 751;

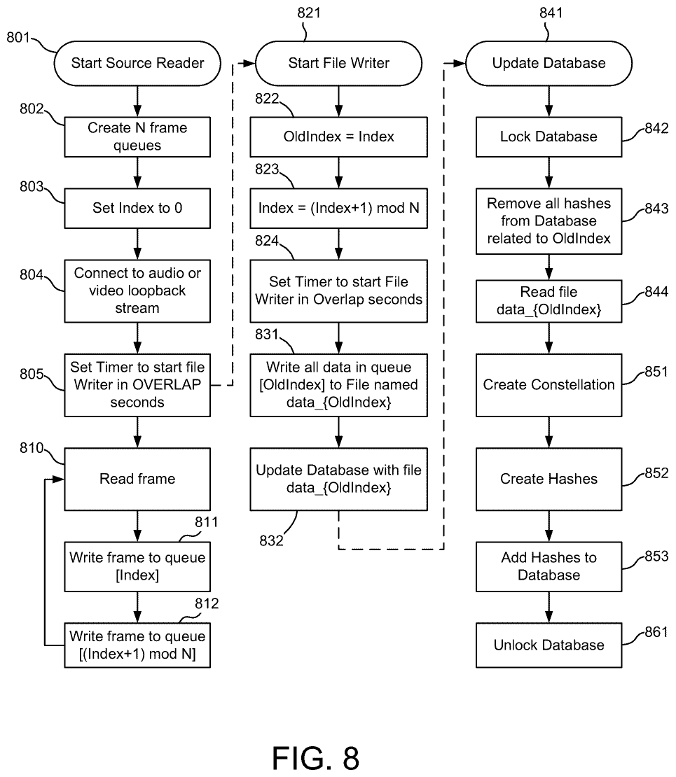

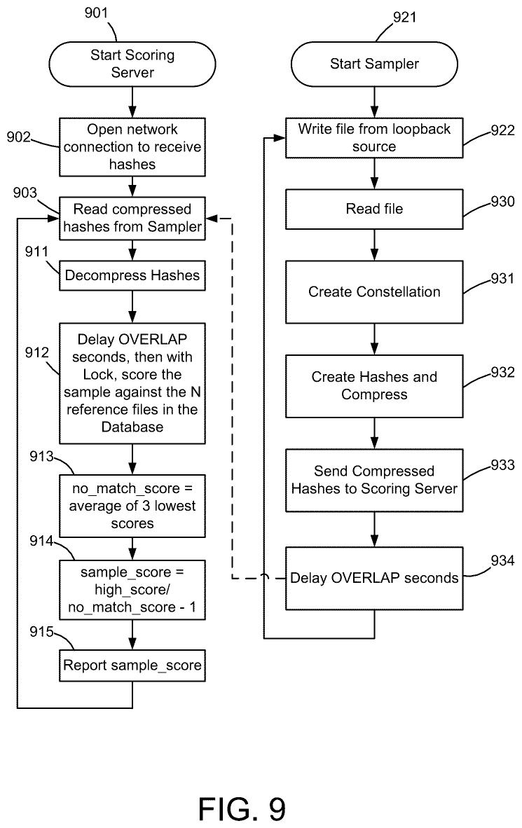

FIGS. 8 and 9 are flow charts showing three process: (1) database creation and management-contains Source Reader, File Writer, and Update Database; (2) scoring server; and (3) a sampler. The variables include: a database for storage of the hashes for each recorded file; “overlap,” which describes the number of seconds of overlap of the recorded files (for example, if the overlap is 15 seconds, then the files will be 30 seconds long, overlapping by 15 seconds); and N, which is the number of files to save in the database. An index is used to keep track of the current file being recorded and written.

In FIG. 8, the first step is to start the source reader 801, which creates N frame queues 802, sets the index to zero 803, and connects to the loopback stream 804. The timer is set to start the File Writer in OVERLAP seconds 805. The loops are forever doing: (1) read frame from loopback 810; (2) write frame to both queue [index] 811 and queue [(index+1) mod N] 812. This step is writing the data to two places that will later be put into separate files to create the overlap.

Next in FIG. 8, the file writer is started 821, the variable OldIndex is set, OldIndex=Index 822, this is to save the index of the file to write, then the variable Index is set, Index=(Index+1) mod N 823, which moves the Source Reader to the next file. Then, the timer is set to start the File Writer again in OVERLAP seconds 824, and the algorithm proceeds to write all data in queue [OldIndex] to file data_{OldIndex}, ex. “data_0” 831 and update the database with file data_{OldIndex} 832.

Finally, in FIG. 8 the database is updated 841, by first Locking Database 842, and removing all hashes related to OldIndex 843, and reading the file data_{OldIndex} 844. The constellation is then created 851 by known methods, the hashes are created 852, the hashes are added to the database 853, and the database is unlocked 861.

FIG. 9 shows a scoring server and sampler flow chart detailed. The first step is to the start the scoring server 901, open a network connection to receive sample hashes 902. Under a continuous loop, the compressed hashes from sampler are read 903, the hashes are decompressed 911, the delay OVERLAP in seconds to make sure the sample is in the database 912. The no_match_score is created 913. Assuming N>4, the lowest 3 scores will be where the sample does not match. Next the sample_score is determined from taking the highest score and dividing by the average of the 3 lowest scores, then subtract one 914. This will give a score of 0 in most cases where there is no match, and a much higher number for matches. Finally, the sample score is reported 915.

Next, in FIG. 9, the sampler is started 921, and in a continuous loop 922, the following steps occur: (1) write file from loopback source; (read file) 930; (2) create Constellation 931 and Hashes as is shown in the prior art. Compress Hashes 932; (3) send Sample Hashes to Scoring server for scoring 933; and (4) delay OVERLAP seconds 934 to allow the scoring server to finish recording the last clip of the source.

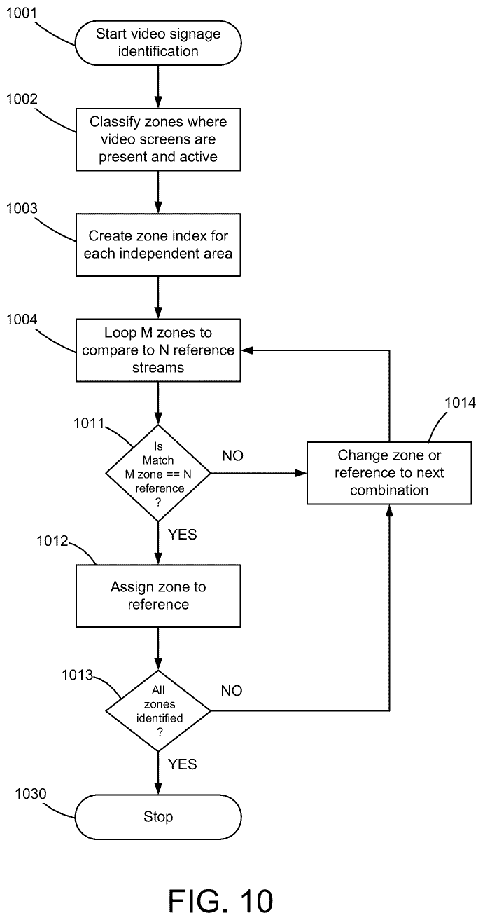

Next, in FIG. 10, the start video signage identification 1001 process is started where the first step is to classify zones where the video screens are present and active 1002. A create zone index for each independent area 1003 is setup to start the analysis for each display component. A loop is setup to loop M zones to compare N reference streams 1004 where M is the current index number for up to N different reference streams. If there is a match to M zone is equal to the N reference 1011 video stream is yes then proceed to assign zone to the reference 1012. If the result of 1011 is no then change zone or reference to next combination 1014 and return to 1004. Once the step 1012 is completed the if all zones identified is yes then stop 1030. If 1013 is no then perform 1014 and return to 1004.

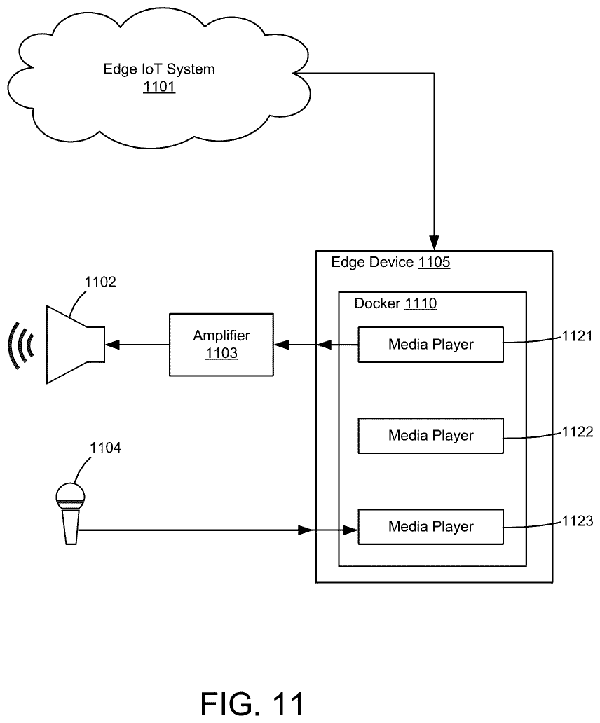

In FIG. 11, the edge computer ecosystem where the edge IoT system is a cloud application 1101 and portal that connects to and controls the edge computer devices 1105 by downloading and running docker containers 1110 on the edge computer devices. In this embodiment there are three docker containers running on the device which are (1) media player 1121, (2) database 1122 and (3) audio validator 1123. The audio validator 1123 container can validate that the audio being played by the media player 1121 can be heard in the desired environment. It makes use of the said algorithms to do the validation of short audio recordings in the environment with the source audio from the media player that is amplified 1103 then sent to a loudspeaker 1102. The audio validator container is designed to simply validate that the source audio is being heard in the environment in near real time by a microphone 1104 signal sent to the audio validator. The first algorithm is used with a small set of overlapping audio clips of the source audio to compare to the smaller recorded audio samples to verify that the source audio can be heard that creates a small vector data array.

For edge devices running the Linux operating system an Alsa audio loopback is used to acquire the source audio media player 1121 and an internal or USB connected microphone 1104 to acquire the recorded audio in the environment. When the environment is further away than the 16-foot limit of USB 2.0 cables, extenders may be used. USB repeaters can extend the length to 98 feet and may be daisy chained. USB cat-5 extenders can extend the distance to over 300 feet.

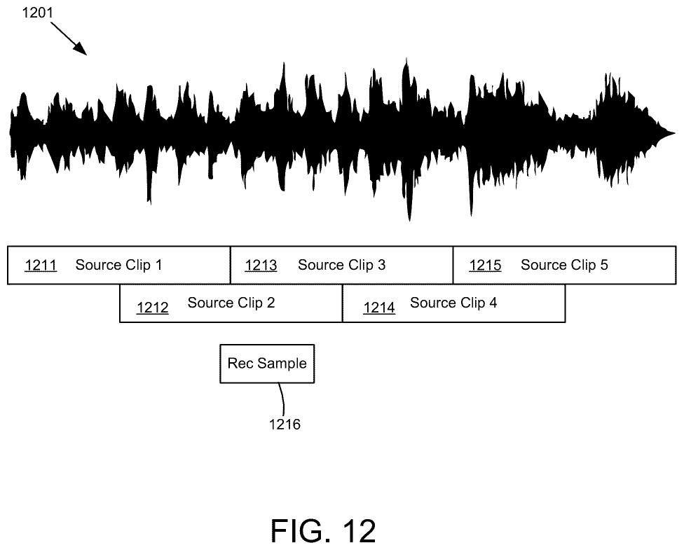

Referring to FIG. 12 where the source audio is used to create rolling vector data array of 5 audio clips of 30 seconds each that overlap by half (15 seconds). This is 90 seconds of source audio. Audio samples of 12 seconds are recorded from the environment using a microphone to compare to the list of 5 source audio clips. Since the source audio clips overlap, and the recorded sample is less than half the length of the clips, it is guaranteed that the recorded audio sample will be wholly contained in at least one of the source clips. The best mode is operating when there is no gap between the adjacent sound clips of interest. FIG. 12 shows a similar representation to FIG. 1 but there are no gaps between a sequential source sound clips. The audio signal of amplitude versus time 1201 is shown as a rec sample. A short data set is designated as source clip 1 1211, source clip 2 1212, source clip 3 1213, source clip 4 1214, and source clip 5 1215. The recorded sample 1216 is wholly in source clip 2, partially in source clips 1 and 3, and not at all in clips 4 and 5. The length of the clips may be different from 30 seconds overlap by half and 12 seconds for the recorded sample. The source clips must overlap by half and the recorded sample must be less than half the source clips length to make sure that it is wholly contained in a single clip. For example, the source clips could be 20 seconds (overlap by 10), and the recorded sample could be 9 seconds.

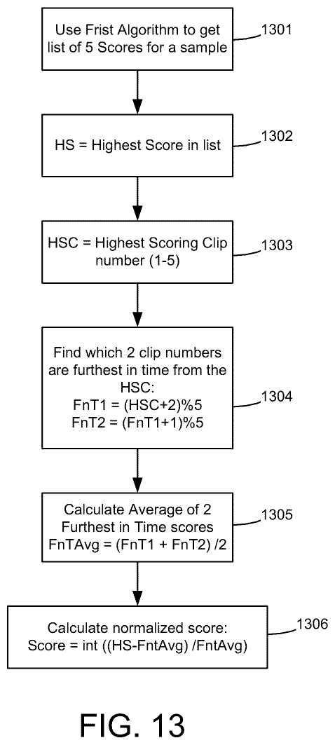

FIG. 13 shows the scoring process when running the first algorithm on the sample and the source library (the group of 5 source clips) 1301, a list of 5 scores is returned. These scores are the number of hashes that match from the sample and the source clips. The higher the score, the more likely it is that there is a match. Depending on the parameters used in the algorithm, the scores can be small numbers or very large numbers. To normalize the scoring, it is determined how the high score (the one that contains the full clip) compares to the average of the 2 clips that are furthest away in time (the ones that do not have any of the clip). This normalized Score now tells how many times higher was the score from the source clip that likely contains the recorded sample over the source clips that do not. A score of 2 or more indicates that the signal in the audio is audible. A higher score indicates that it is even more easily heard.

The process finds the highest score in the list 1302, along with its clip number 1303. The two clip numbers that are farthest in time from the highest scoring clip are determined 1304. The average of those two farthest away clips is calculated 1305. Finally, the normalized score is calculated 1306, by subtracting the farthest away average score from the high score and then dividing by the farthest away average score.

The normalized score is written to the Database 1122, along with other data such as a 7-score running average, the percentage of hashes that match, and the volume level of the microphone. These data items may then be displayed on an attached display or a web page. Further, the Media Player 1121 may read the data from the Database 1122 to allow for adjusting the volume level of the source audio to increase the score, making the audio more likely to be audible. For example, if the microphone level increases during a certain time of day, indicating that the environment is noisy, then the Media Player 1121 can increase the volume of the audio signal to compensate. When the noise level subsides then the volume is lowered to the standard set point.

The first algorithm has several parameters that can be adjusted. These adjustments can affect the performance of the algorithm, the size of the fingerprint data (number of hashes), and the value of the scores. The audio validator allows for changing these parameters. This is important to help investigate how small the fingerprint data can be and still have an effective algorithm when looking at low bandwidth devices. The parameters of interest are (1) sample rate, (2) window length, (3) peaks, (4) frequency limit, (5) pair box. The Sample Rate is the sample rate given to the recording program. The maximum frequency recorded is ½ the Sample Rate. A Sample Rate of 16000 will have a recording max frequency of 8000 Hz. Valid values Sample Rate are 2000 to 192000. Since the purpose of Audio Validator is to recognize that advertisements can be heard, the important frequencies are between 300 and 3400 Hz. Therefore, a sample rate of 7000 is best mode for validating music and voices while keeping from creating unnecessary hashes at higher frequencies. The window length is the amount of time in seconds for the length of the window. The window is the portion of the audio that has the FFT processing to determine the frequency peaks. This value determines how many windows of will be used to create hashes. Given the use of 12 seconds for the length of a recorded sample, a window length of 0.2 seconds gives us 60 windows to evaluate. The larger the window length, the fewer the number of windows. Normally, this value should be a small fraction of the recorded sample length, so there are enough windows to evaluate. More windows create a larger fingerprint. The peaks is the number of peaks gathered in the specified window. The range is anything greater than 0, although high numbers will greatly increase the size of the fingerprint. A value of 10 with the number of windows at 60 provides 600 frequency peaks to process. This is the best compromise between accuracy and size of fingerprint. The frequency limit is used to create the binning frequency of the hashing. The binning frequency is the minimum of sample rate/2 and the frequency limit. Therefore, the frequency limit can be used to further reduce the frequencies that will be processed when creating hashes. For validating music and ads, most of the data is below 3500 Hz, so this is a best value to use. To reduce the number of hashes created, frequency limit may be reduced further than ½ the sample rate. The frequency limit may be set to any value up to ½ the sample rate. Pair box describes the box used to select the pairs of peaks used to make the hashes. Start is the minimum time in seconds for a peak to be considered. End is the maximum time in seconds for a peak to be considered. Frequency range describes the maximum difference in frequency for a peak to be considered. Both Start and End should be well below the length of the recorded source. Frequency range can vary from 10 Hz to the Frequency limit. The best values for a good tradeoff between accuracy and size are Start=1, End=4, and Frequency range=500 Hz. A larger pair box creates a larger fingerprint, and a smaller pair box creates a smaller, less accurate fingerprint.

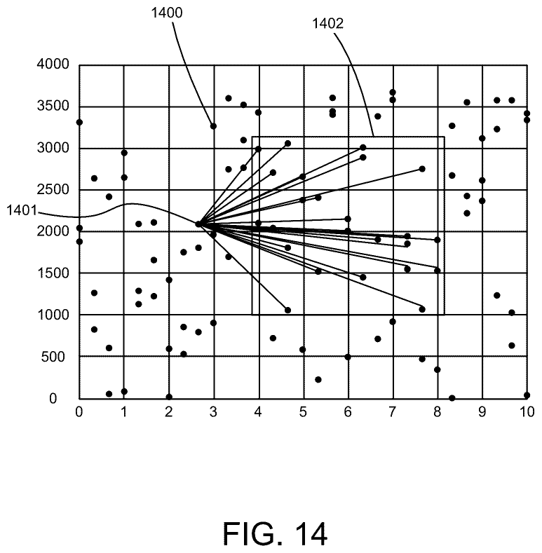

FIG. 14 shows the pair box that has spectral components that are present at a given time. Note that any sound instance may have multiple frequency content simultaneously. The points on the graph are frequency peaks at a given time 1400. The anchor point 1401 is the point being processed. The Target Zone (also known as Pair Box) 1402 is the area that determines which points that will be matched with the anchor point to make frequency pairs.

A normalized score is reported after each sample is scored against each vector data array. The reporting is done to the database 1122 container in FIG. 11. This way the data may be read by the media player for its uses 1121. The scored information that is reported and contains (1) time stamp of sample, (2) score, (3) running average of last seven scores, (4) hash match percentage, (5) microphone volume, (6) number of hashes, and (7) compressed size of hashes.

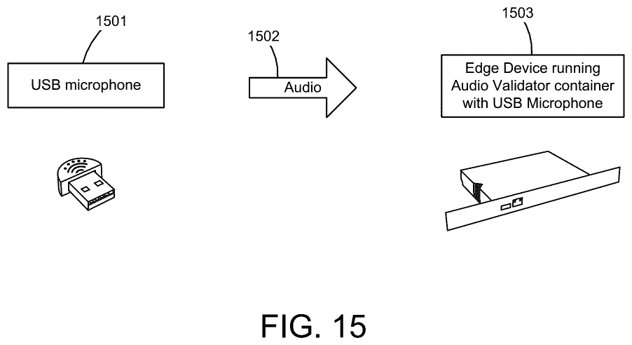

FIG. 15 shows hardware elements used in the current embodiment can accept samples from an onboard microphone on the edge device 1503, or a USB connected microphone 1501 that sends audio data 1502 to the edge device. In most cases the environment where the audio is heard is far from the rack-mounted edge device.

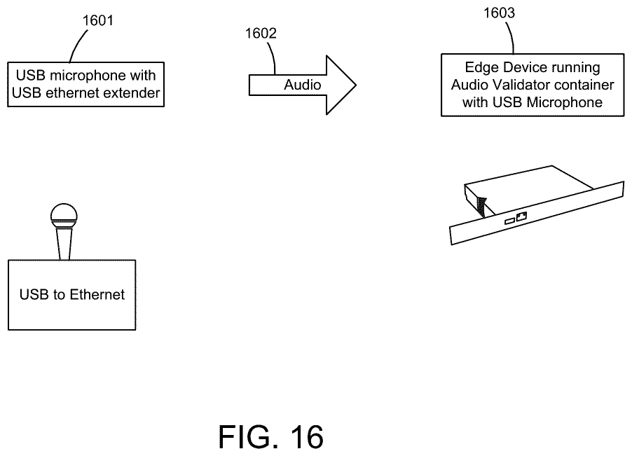

FIG. 16 shows a USB extender 1601 can be used to place a USB microphone in the environment, sending audio data 1602 to the edge device 1603.

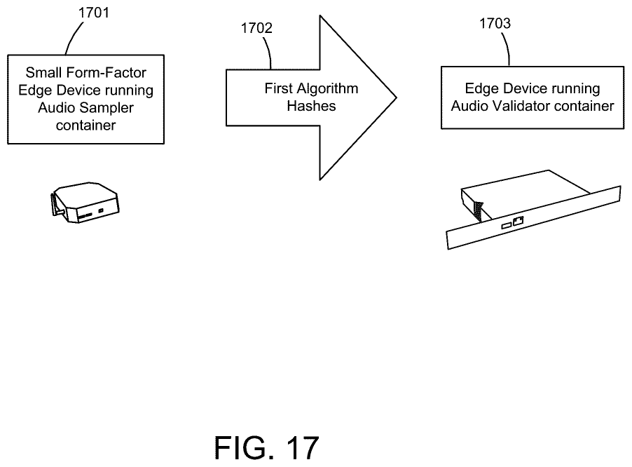

FIG. 17 shows multiple devices, a rackmounted edge device 1703 and a small form-factor edge device 1701 running another docker container, the audio sampler container. Audio Sampler takes a sample from its built-in microphone, creates the first algorithm hashes 1702, and then sends them to the edge device that is running the audio validator container 1703. In this case a small form-factor edge device is used with an internal microphone to acquire samples and send the first algorithm hashes to an edge device running the audio validator container.

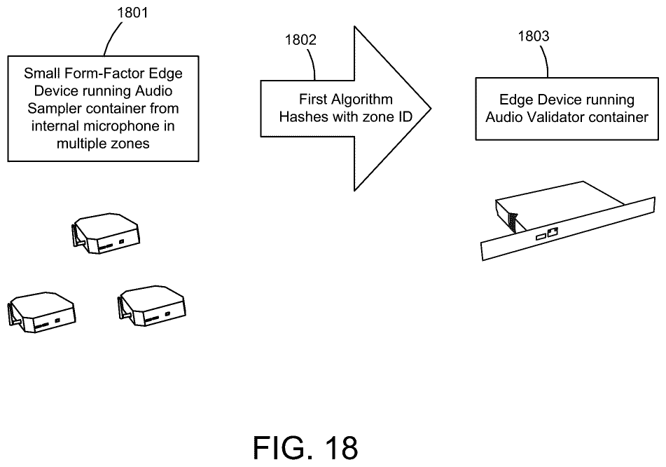

FIG. 18 shows multiple devices where each small form-factor edge device 1801 is in a different zone of the environment. The zone ID is included with the first algorithm hashes 1802 so each zone can be scored separately by the edge device running Audio Validator 1803.

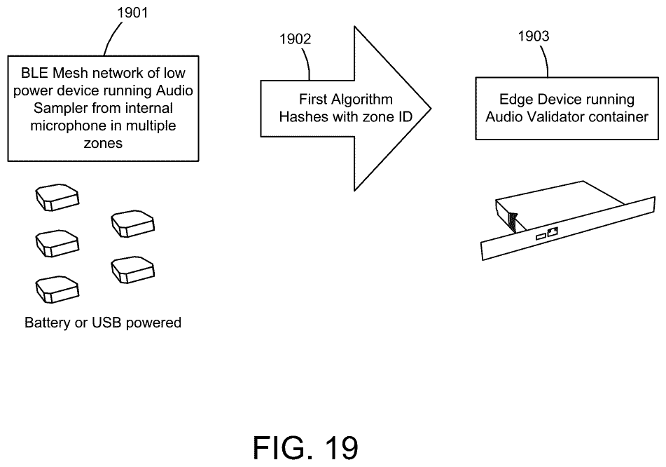

FIG. 19 shows a more cost-effective solution, low-power/low-bandwidth devices may be used 1901. For example, low-cost devices may be used in a BLE mesh network to collect audio samples and send the first algorithm hashes with zone ID 1902 to the audio validator container running on the rack mounted edge device 1903 for scoring. With this solution, there may be many sampling devices, even one for every speaker in the environment.

In the multi-device scenarios, the audio sampler sends first algorithm hashes to the audio validator for scoring and reporting. For the first algorithm to work it is required that the recording of the source and the sample be processed with the same parameters to create the first algorithm hashes. Therefore, the parameters used must be included in the data sent to the audio validator.

The audio sampler may be running on an edge device or a low-cost BLE mesh network device. in the edge device case, the connection to audio validator is over ethernet or WiFi on a local network. This means that the size of the first algorithm hashes is not a primary concern. In the case of the low-cost devices, that have very low bandwidth connection to the audio validator over the BLE mesh network, keeping the size of the first algorithm hashes is paramount.

Therefore, there must be at least 2 sets of parameters. One that creates a larger set of first algorithm hashes for better accuracy, and one that creates a very small set of first algorithm hashes that can be sent over a low-bandwidth connection. These sets of parameters are called “profiles”. Each profile contains (1) sample length in seconds, (2) sample rate, (3) number of peaks, (4) window length, (5) frequency limit, and (6) pair box (start, end, freq_range).

Profile 0 is the standard default profile for devices on high-bandwidth networks, such as ethernet and WiFi. The list of values best mode for this profile are (1) sample length=12 sec, (2) sample rate=7000 hz, (3) number of peaks=10, (4) window length=0.2 sec, (5) frequency limit=3500 hz, and (6) pair box (start=1, end=4, freq_range=500 hz).

Profile 1 is the profile for devices on low-bandwidth networks, such as BLE Mesh network. The list of best mode values for this profile are (1) sample length=12 sec, (2) sample rate=7000 hz, (3) number of peaks=5, (4) window length=0.4 sec, (5) frequency limit=3500 hz, and (6) pair box (start=2, end=4, freq_range=300 hz).

Other profiles may be added to help with specific environments.

The zone of the device (an identifier indicating the location of the device) is also required to be included in the data sent to the audio validator. Therefore, the data sent to the audio validator consists of (1) profile number, (2) zone and (3) first algorithm hashes (in a compressed format).

The audio validator will spin up a recording thread specific to each different profile that is used by an audio sampler that connects to it. The audio validator will use the zone in its reporting of the score of the first algorithm hashes.

The communication between audio sampler and audio validator is over TCP on a predefined port that is known to all devices. The audio sampler may have the IP address of the audio validator in its environment variables set up on the edge IoT System. If not, it can scan all devices on the local network for a device that is listening on port the predefined port.

The assignment of a zone to each audio sampler device is controlled by the edge IoT system. The zone is a string. It will appear in the environment variables of the audio sampler in “AudioSamplerZone.” If this variable is not present, then the zone to be used is “None.”

When multiple audio samplers are sending data to audio validator, the zone must also be reported to the database in FIG. 11. The contents of the reported record when using multiple zones are (1) time stamp of sample, (2) zone of sample, (3) score, (4) running average of last seven scores from zone. (5) hash match percentage. (6) microphone volume from zone. (7) number of hashes, and (8) compressed size of hashes.

We claim:

1. A method of enrolling a reference signal for audio validation of a recorded sample snippet comprising:
capturing an audio signal of a known duration; and
dividing the audio signal into separate audio stream portions for processing where the divided audio stream portions overlap by at least the amount of time of the sample snippet to allow the sample snippet to always be located within a particular audio stream portion.

2. The method of claim 1, where the portions are organized in a database or logical sequence to keep a sliding window of reference signals from the present time to the end of a validation window.

3. The method of claim 1, where the sample snippets are scored against each of the source audio stream portions using an algorithm such as the first algorithm, where a score is created for each source audio stream portion that indicates the likelihood that the sample snippet is contained in that source audio stream portion.

4. The method of claim 3, where the highest score, Score, is normalized based on the normalized highest score to be put in a database found by:
finding the highest listed score defined by HS;
finding the highest scoring clip number defined by HSC;
finding the two furthest clip numbers in time defined by FnT1 which equal to
(HSC+2) % 5, and
FnT2 which is equal to
(FnT1+1) % 5;
calculating the furthest in time scores defined by FnTAvg is equal to
(FnT1+FnT2)/2; and
calculating normalized score defined by Score is equal to int((HS−FnTAVG)/FntAvg).

5. The method of claim 4, where additional data is stored in the database including:
a seven-score running average, percent of matching hashes, or sound level of the microphone is recorded to a database in an edge device.

6. The method of claim 5, where the data written to the database is displayed in graphical form on an attached display or a web page.

7. The method of claim 5 where the data is read from the Database by the Media Player in an edge device, so that the volume of the source can be adjusted.

8. A method to create classifications of sound types to be matched in time, comprising:
correlating predetermined sound or video snippets from the audio or video streams;
for each of the snippets, sending a flag if the correlation is above a threshold, where thresholds and duration requirements would be dynamic so that a desired hit rate would be acquired;
training a classifier to identify a range of instruments, voices, and expected sounds that would be expected to be present in a reference signal;
identifying a sounds with time stamps (relative or absolute) for a start or end of the classification for a reference classification that would create a window of metrics such as a length of classification with time; and
storing the reference classification for a sufficient time so that the slowest remote device could transmit its comparison data and be processed.

9. The method of claim 8, where remote sensors have similar classification software that detect the same sound sets as the reference signal uses.

10. The method of claim 8, where each time a positive classification is made at the remote sensor, the classification type and times are sent for a match, and signals received at the same time intervals within an allowable tolerance will be considered a match.

11. The method of claim 8, where the predetermined sound or video snippets are a few cycles of a pure sinusoidal snippets at different frequencies.

12. The method of claim 8, where if validation is required for every 30 seconds, then the duration and threshold would self-adjust until that rate is created.

13. The method of claim 8, where the number of matches can be controlled by choosing the signal reference types.

14. The method of claim 8, where the same algorithms would be on the sensor device in a remote location and the dynamic thresholds would be communicated to the sensor that would adjust and listen.

15. A method of validating video stream content, comprising:
acquiring the reference video server signal as a digital signal for frame-by-frame processing;
converting the frame data into a signal that is easy to evaluate for a key fingerprint (hash), hashes are created from peaks in the video stream;
using one or more remote cameras to observe the displays of interest with sufficient line of sight;
isolating the displays of interest areas from each frame of the observing camera;
performing a fingerprint analysis for each isolated display area from observing camera;
sending observed key fingerprint results to the evaluation server;
performing matches to see count of like hashes; and
setting a threshold to determine the acceptance or rejection criteria.

16. The method of claim 15, where for video sequences, signals may be represented as spectral content that have peaks that change sufficient to be used as the fingerprint hash.

17. The method of claim 16, where each color is averaged over some snippet of time, which will give a fingerprint for the general background color.

18. A method of installing a system to validate audio streaming content, comprising:
initiating a calibration routine, which will begin a sequence of audio tones of various frequencies and amplitudes during a period of minimal non-standard ambient noise;
standing at various positions to determine when the audio is clearly audible to their human ears and remove their finger from the mobile device during times when the audio is unclear, muffled, or inaudible;
cross-referencing positions against a matching score the system generates for the various frequencies, sound types (spoken voice vs music, etc.), and audio amplitudes; and
calibrating a single sensor across all sensors in a facility to normalize matching scores for each sensor and ultimately across multiple facilities.

19. The method of claim 18, where a video stream is validated and the sensor is a camera that is placed such that the video monitor being evaluated is within the field of view of the camera.

20. The method of claim 19 where during a calibration process, a known blinking pattern of color blocks is presented at various brightness levels (on screen) and at various pattern frequencies.
